(19) United States
(12) Patent Application Publication
(10) Pub. No.: US 2023/0367993 A1
(43) Pub. Date: Nov. 16, 2023

(54) DNN CONTRACTION DEVICE AND ONBOARD COMPUTATION DEVICE

(71) Applicant: HITACHI ASTEMO, LTD., Hitachinaka-shi, Ibaraki (JP)

(72) Inventors: Sakie KOMATSU, Hitachinaka (JP); Hiroaki ITO, Hitachinaka (JP)

(73) Assignee: HITACHI ASTEMO, LTD., Hitachinaka-shi, Ibaraki (JP)

(21) Appl. No.: 18/248,391

(22) PCT Filed: Sep. 1, 2021
(86) PCT No.: PCT/JP2021/032111

§ 371 Date: Apr. 10, 2023

(30) Foreign Application Priority Data
Nov. 16, 2020 (JP) 2020-190138

(51) Int. Cl. G06N 3/04

(52) U.S. Cl. CPC G06N 3/04

(57) ABSTRACT

A DNN contraction device (100) outputs a reduced DNN to a DNN computation unit (300) that performs a DNN computation using an internal memory. The DNN contraction device (100) includes an output data size measurement unit (110) and a data contraction unit (120). The output data size measurement unit (110) measures the output data size in the DNN layer from the DNN network information. The data contraction unit (120) sets a contraction number of the DNN layer based on the output data size and the memory size of the internal memory.

### TECHNICAL FIELD

The present invention relates to a DNN contraction device and an onboard computation device.

### BACKGROUND ART

In recent years, techniques for applying object recognition and behavior prediction using machine learning to automatic driving of a vehicle have been developed. In addition, a deep neural network (DNN) is known as a machine learning method applied to object recognition or the like. The DNN includes learning processing of acquiring a feature of an object and inference processing of extracting an object based on a learned result. In general, when automatic driving is performed using a DNN, first, an external image is acquired from a camera and converted into a format usable in the DNN. In the inference processing, an object is extracted using a DNN subjected to learning processing in advance using the transformed image as an input image. Thereafter, a surrounding map is created from the object extraction result, an action plan is made based on the result, and the vehicle is controlled.

In PTL 1, weights with low importance are selected and deleted in the DNN, thereby reducing computation impossibility while suppressing degradation in recognition accuracy. In addition, in PTL 2, the data amount used for computation is reduced by converting data in DNN computation.

### CITATION LIST

### Patent Literature

PTL 1: JP 2020-042496 A

PTL 2: JP 2019-106059 A

### SUMMARY OF INVENTION

### Technical Problem

The DNN repeatedly executes a convolution operation including multiplication and addition, and thus the number of times of computation is very large. In addition, since it is necessary to continuously update the action plan within a very short time particularly in automatic driving, high-speed computation is required for object extraction by DNN, and high accuracy is required, so that the computation data becomes large.

In addition, in the computation device in which the DNN is mounted, the memory size of the internal memory is often smaller than the computation data size, and the computation data is divided for each internal memory size to perform the arithmetic operation of the DNN. In addition, when data is transferred from a device mounted with a DNN to an external memory such as a double-data-rate SDRAM (DDR), computation data is divided and transferred for each internal memory size. Therefore, by reducing the amount of computation based on the internal memory size, the optimal amount of computation can be reduced. However, even if the computation amount is reduced as in PTLs 1 and 2, the computation data based on the internal memory size is not reduced, and the optimum amount of computation is not reduced.

In view of the above points, an object of the present invention is to provide a DNN contraction device and an onboard computation device capable of realizing a reduction in an arithmetic amount based on an internal memory size in a DNN computation.

### Solution to Problem

In order to achieve the above object, an example of the present invention is a DNN contraction device that outputs a contracted DNN to a DNN computation unit that performs a DNN computation using an internal memory, the DNN contraction device including: an output data size measurement unit that measures an output data size in a DNN layer from DNN network information; and a data contraction unit that sets a contraction number of the DNN layer based on the output data size and a memory size of the internal memory.

### Advantageous Effects of Invention

According to the present invention, it is possible to reduce the amount of computation based on the internal memory size in the DNN computation. Objects, configurations, and effects besides the above description will be apparent through the explanation on the following embodiments.

### BRIEF DESCRIPTION OF DRAWINGS

FIG. 1 is a block diagram illustrating a simplified configuration example of an automatic driving system according to a first embodiment.

FIG. 2 is a diagram illustrating an example of a network configuration of a DNN.

FIG. 3 is a diagram illustrating an example of data division of the DNN.

FIG. 4 is a diagram illustrating an example of data division of the DNN after contraction.

FIG. 5 is a block diagram illustrating a configuration example of an automatic driving system according to the first and second embodiments.

FIG. 6 is a block diagram illustrating a simplified configuration example of an automatic driving system according to a third embodiment.

FIG. 7 is a block diagram illustrating a configuration example of an automatic driving system according to the third embodiment.

FIG. 8 is a flowchart illustrating processing of a recognition accuracy confirmation unit.

FIG. 9 is a block diagram illustrating a simplified configuration example of an automatic driving system according to a fourth embodiment.

FIG. 10 is a block diagram illustrating a configuration example of an automatic driving system in the fourth and fifth embodiments.

FIG. 11 is a block diagram illustrating a simplified configuration example of an automatic driving system in a sixth embodiment.

FIG. 12 is a block diagram illustrating a configuration example of the automatic driving system in the sixth embodiment.

FIG. 13 is a block diagram illustrating a configuration example of an automatic driving system in a seventh embodiment.

FIG. 14 is a flowchart illustrating processing of a recognition accuracy confirmation unit.

### DESCRIPTION OF EMBODIMENTS

Hereinafter, an automatic driving system including a DNN contraction device or an onboard computation device according to first to seventh embodiments will be described with reference to the drawings. An embodiment of the present invention relates to a process of reducing the number of times of computation of a deep neural network (DNN), in particular, in an automatic driving system that controls a vehicle to a destination by peripheral recognition, automatic steering, and automatic speed control using the DNN.

### First Embodiment

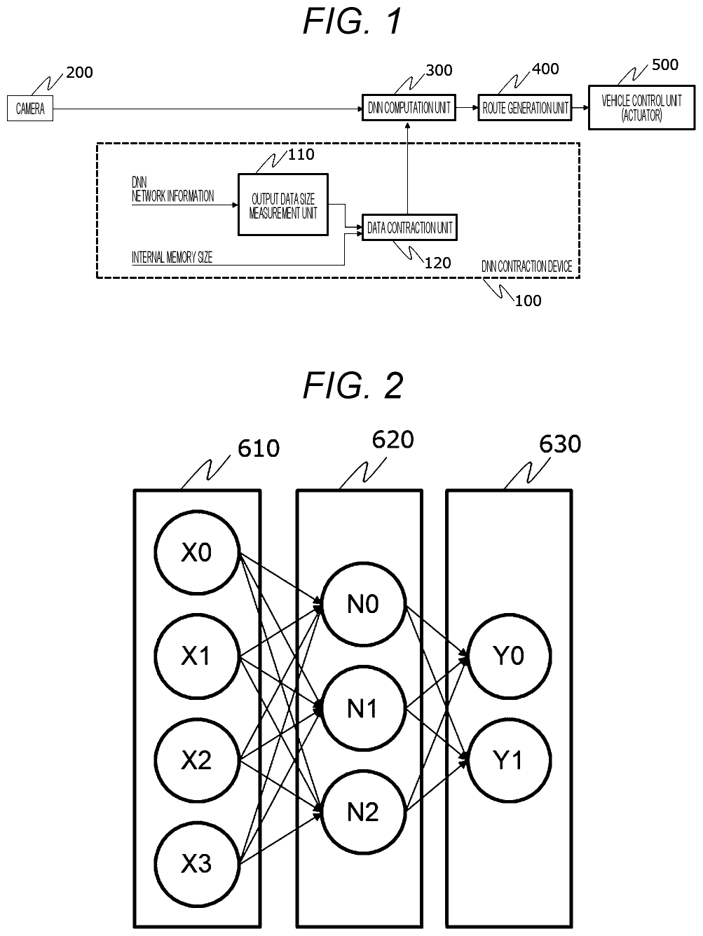

FIG. 1 is a block diagram illustrating an example of a configuration diagram of an automatic driving system using a DNN contraction device 100 of the present embodiment. As illustrated in FIG. 1, the automatic driving system using the DNN contraction device 100 according to the present embodiment includes the DNN contraction device 100, a camera 200, a DNN computation unit 300, a route generation unit 400, and a vehicle control unit 500. Here, the DNN contraction device 100 includes an output data size measurement unit 110 and a data contraction unit 120. Note that the DNN contraction device 100 is configured by, for example, a field programmable gate array (FPGA), but is not limited thereto.

First, the operation of the DNN computation unit 300 will be described. The DNN computation unit 300 performs image recognition processing on the external information acquired from the camera 200 using the DNN after contraction which is output from the data contraction unit 120 described later. The route generation unit 400 generates an action plan such as the traveling direction and the traveling speed of the vehicle using the information of the recognition result processed by the DNN computation unit 300, and outputs the action plan to the vehicle control unit 500. The vehicle control unit 500 controls the vehicle based on the output from the route generation unit 400.

Next, the operation of the DNN contraction device 100 will be described. FIG. 2 is a diagram illustrating an example of a DNN held by the DNN contraction device 100 of FIG. 1. In FIG. 2, reference numeral 610 denotes an input layer, reference numeral 620 denotes an intermediate layer, and reference numeral 630 denotes an output layer. At this time, four values of X0 to X3 are input in the input layer 610, and Y0 and Y1 are output in the output layer 630 via the computation in the intermediate layer 620. N0 to N3 in the intermediate layer 620 are referred to as nodes, and each input value is multiplied by a weighting coefficient for each input, and the result is added and output. At this time, assuming that the data amount at N0 is d(N0) and the number of times of computation for obtaining N0 from the inputs X0 to X4 is c(N0), since there are three nodes in the intermediate layer 620, the data amount and the number of times of computation in the intermediate layer 620 in FIG. 2 are obtained as follows.

d(N)=d(N0)+d(N1)+d(N2)=3*d(N0) (Expression 1)

c(N)=c(N0)+c(N2)+c(N2)=3*c(N0) (Expression 2)

Note that * is a multiplication symbol.

Next, the inputs X0 to X3 and the outputs Y0 to Y1 in FIG. 2 will be described with specific examples. The DNN after contraction output from the data contraction unit 120 is used by the DNN computation unit 300, and the image information output from the camera 200 is input to X0 to X3, and the computation results Y0 to Y1 of the DNN are used as image processing results for the image, for example, the probability that the image is a vehicle is Y0 and the probability that the image is a pedestrian is Y1.

As described above, the DNN network information is stored in the DNN computation unit 300. Note that, for convenience of description, the configuration of the DNN is simplified as illustrated in FIG. 2, and the number of intermediate layers 620 is 1 and the number of nodes in the intermediate layer 620 is 3. However, some DNNs actually used have a configuration in which the intermediate layer 620 is divided into a plurality of layers and the number of nodes is several tens.

In addition, in a device used in an embedded system such as the automatic driving system as in the present embodiment, the memory size in the device may be smaller than the data size used in the processing in each layer of the DNN. Therefore, a method of dividing data for each internal memory size and performing computation is used. In addition, in the DNN, data is transferred in order to store computation data in a large-capacity external memory such as DDR every time each layer performs computation. Also at that time, data transfer is performed by dividing the computation data for each internal memory size.

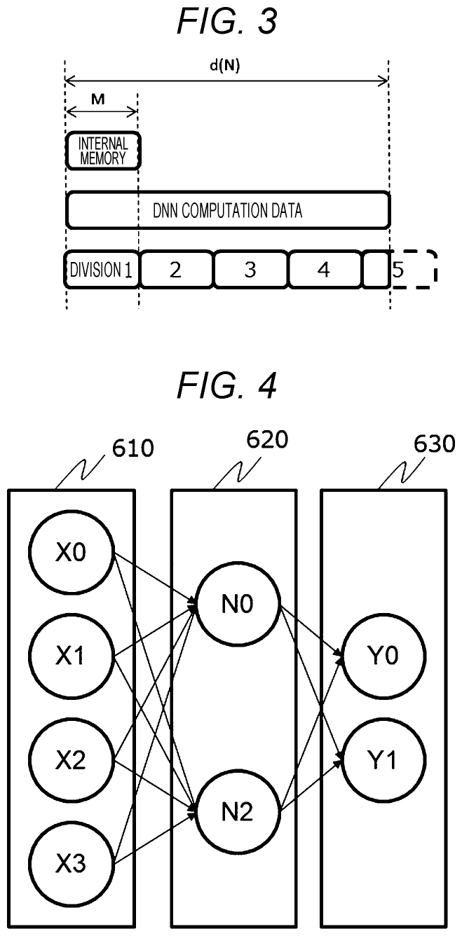

FIG. 3 illustrates an example of computation data division performed for DNN computation in the device. The DNN computation data indicates the data d(N) used in the processing performed between the input layer 610 and the intermediate layer 620 illustrated in FIG. 2, and the internal memory indicates the memory size M inside the device for performing the DNN computation. As illustrated in this drawing, when there is a remainder when the computation data is divided by the internal memory size, it is necessary to handle the remainder data as one time of computation.

Therefore, the number of divisions of the computation data at this time is obtained as follows.

ROUNDUP(d(N)/M,0) (Expression 3)

ROUNDUP(A, B) indicates that the value of A is rounded up by the number of digits of B. For example, in Expression 3, since B=0, the first decimal place is rounded up, and an integer value is returned.

In order to examine the number of divisions of data in this manner, the DNN contraction device 100 includes the output data size measurement unit 110 that measures (calculates) the output data size in each layer from the DNN network information held in the DNN contraction device 100, and holds the memory size of the internal memory of the device on which the DNN is mounted.

Next, the operation of the data contraction unit 120 will be described. The data contraction unit 120 performs processing of reducing the number of times of computation of the DNN. The DNN computation reduction method includes several methods, and the Pruning method will be described below. The Pruning method determines that the influence on the output is small when the absolute value of the weighting coefficient indicating the importance of the DNN computation is less than a predetermined threshold, and omits the computation.

As an example of the Pruning, FIG. 4 illustrates a diagram after applying the Pruning to the diagram of FIG. 2. As a result of the Pruning, as illustrated in FIG. 4, all the computation from the inputs X0 to X3 to N1 are unnecessary, and the node N1 is unnecessary.

Further, since the data amount and the number of times of computation in the intermediate layer 620 of the DNN are obtained in a similar manner to (Expression 1) and (Expression 2), the data amount d(Np) and the number of times of computation c(Np) after Pruning in FIG. 4 are as follows.

d(Np)=2*d(N0) (Expression 4)

c(Np)=2*c(N0) (Expression 5)

As described above, in the Pruning method, the number of times of computation and the data amount are reduced by deleting the computation between the nodes considered to have a small influence on the output.

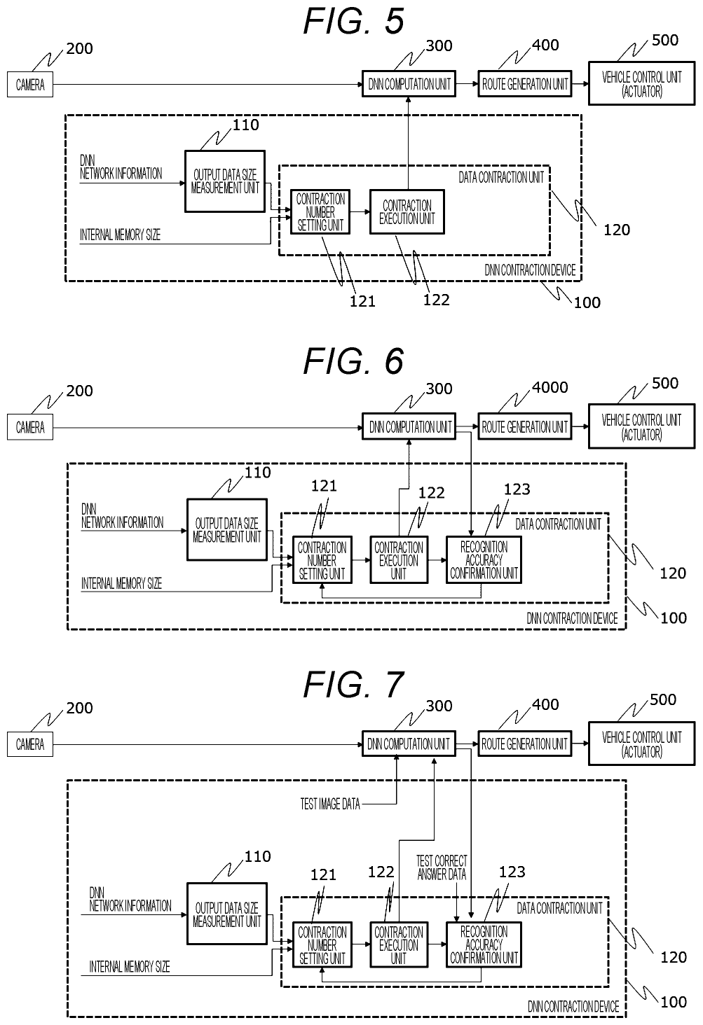

In addition, FIG. 5 illustrates a detailed view of the data contraction unit 120 of FIG. 1. In FIG. 5, the same names and numbers are assigned to blocks that perform the same processing as in FIG. 1, and unless otherwise described, the blocks are assumed to have the same or similar functions, and the description thereof will be omitted. In FIG. 5, the data contraction unit 120 includes a contraction number setting unit 121 and a contraction execution unit 122.

In the present embodiment, the contraction number setting unit 121 sets the contraction amount of the DNN so that the DNN computation data size is equal to or less than the memory size of the internal memory from the DNN computation data size and the internal memory size in the layer that is the output from the output data size measurement unit 110. The contraction execution unit 122 performs contraction of the DNN based on the contraction number set by the contraction number setting unit 121, and outputs the DNN after contraction to the DNN computation unit 300.

As a result, it is possible to perform contraction of the DNN assuming division by the internal memory size that cannot be considered in general Pruning, and it is possible to perform an efficient computation using the internal memory and to reduce the number of times of computation of the DNN and the number of times of data transfer to the external memory.

Hereinafter, the operation of the contraction number setting unit 121 will be described using a specific example.

As an example, it is assumed that the output data size measurement unit 110 measures that the DNN computation data size in a certain layer is 12 MB. In addition, it is assumed that the internal memory size of the device mounted with the DNN is 10 MB. The number of divisions of the computation data of the DNN at this time is ROUNDUP(12/10, 0)=2 from (Expression 3). However, at this time, only 2 MB of the internal memory size of 10 MB is used in the second division. That is, at this time, if the number of times of computation equal to or larger than the amount corresponding to 2 MB can be reduced, the number of divisions can be set to one, and the number of times of computation and the number of times of data transfer can be reduced.

Therefore, the contraction number setting unit 121 sets the number of times of contraction at which the DNN computation data after contraction in a certain layer is 10 MB or less, and outputs the contraction number to the contraction execution unit 122.

Note that, in the present embodiment, the external information is acquired from the camera 200, but this is not limited to the camera as long as it is a sensor capable of acquiring the distance to the object and the type of the object, such as the lidar, the RADAR, and the far infrared camera. In addition, the sensors may be used singly or in combination of a plurality of sensors.

Features of the present embodiment can also be summarized as follows.

As illustrated in FIG. 1, the DNN contraction device 100 outputs a contracted DNN to the DNN computation unit 300 that performs a DNN computation using an internal memory. The DNN contraction device 100 includes at least the output data size measurement unit 110 and the data contraction unit 120. The output data size measurement unit 110 measures the output data size in the DNN layer from the DNN network information. The data contraction unit 120 sets the contraction number of the DNN layer based on the output data size and the memory size of the internal memory. As a result, the DNN computation amount can be reduced.

Specifically, as illustrated in FIG. 5, the data contraction unit 120 includes the contraction number setting unit 121 that sets the contraction number of the DNN layer so that the output data size is equal to or less than the memory size of the internal memory, and the contraction execution unit 122 that reduces the DNN according to the set contraction number. As a result, the utilization efficiency of the internal memory can be improved in the DNN computation.

As described above, according to the present embodiment, it is possible to reduce the amount of computation based on the internal memory size in the DNN computation.

### Second Embodiment

Next, a second embodiment of the present invention will be described. FIG. 5 is a block diagram illustrating an example of a configuration diagram of an automatic driving system using the DNN contraction device 100 of the present embodiment. In FIG. 5, the same names and numbers are assigned to blocks that perform the same processing as in FIG. 1, and unless otherwise described, the blocks are assumed to have the same or similar functions, and the description thereof will be omitted.

In the first embodiment, the contraction number setting unit 121 sets the contraction number such that the DNN computation data becomes equal to or less than the internal memory size, but in a case where the DNN computation data is extremely large with respect to the internal memory size, it becomes difficult to contract the DNN computation data to the internal memory size or less. Therefore, if the computation data can be reduced to an integral multiple of the internal memory size in order to perform the contraction in consideration of the division by the internal memory size, the internal memory can be efficiently used and the computation can be performed without waste regardless of the scale of the DNN computation data and the internal memory size. Therefore, in the present embodiment, the contraction number setting unit 121 sets the contraction number such that the DNN computation data size becomes an integral multiple of the internal memory size from the DNN computation data size and the internal memory size in the layer that is the output from the output data size measurement unit 110.

Hereinafter, the operation of the contraction number setting unit 121 will be described using a specific example.

As an example, it is assumed that the output data size measurement unit 110 measures that the size of the DNN computation data in a certain layer is 102 MB. In addition, it is assumed that the internal memory size of the device mounting the DNN is 10 MB. The number of divisions of the computation data of the DNN at this time is ROUNDUP(102/10, 0)=11 from (Expression 3). However, at this time, only 2 MB of the internal memory size 10 MB is used in the eleventh division. That is, at this time, if the number of times of computation equal to or larger than the amount corresponding to 2 MB can be reduced, the number of divisions can be set to 10, and the number of times of computation and the number of times of data transfer can be reduced.

That is, at this time, the contraction number setting unit 121 sets the contraction number such that the DNN computation data size after contraction in a certain layer is 10 MB*10 times=100 MB or less, which is an integral multiple of the internal memory size.

Note that, in this example, the contraction number is set so as to reduce the number of divisions by the last one time, but the contraction amount may be set so as to reduce the number of divisions two or more times.

Features of the present embodiment can also be summarized as follows.

As illustrated in FIG. 5, the data contraction unit 120 includes the contraction number setting unit 121 that sets a contraction number of a DNN layer such that the output data size becomes an integral multiple of the memory size of the internal memory, and the contraction execution unit 122 that reduces the DNN according to the set contraction number. As a result, the utilization efficiency of the internal memory can be improved in the DNN computation.

### Third Embodiment

Next, a third embodiment of the present invention will be described. FIG. 6 is a block diagram illustrating an example of a configuration diagram of an automatic driving system using the DNN contraction device 100 of the present embodiment. In FIG. 6, the same names and numbers are assigned to blocks that perform the same processing as in FIG. 5, and unless otherwise described, the blocks are assumed to have the same or similar functions, and the description thereof will be omitted.

When the DNN contraction is performed, since a part of the computation is deleted, the recognition accuracy is reduced to some extent, but the recognition accuracy is not confirmed in the first and second embodiments. If the recognition accuracy is not confirmed, even computation that should not be deleted when recognizing an object is deleted, and the recognition accuracy necessary for automatic driving cannot be secured, and safety may be concerned.

In FIG. 6, a recognition accuracy confirmation unit 123 newly added from FIG. 5 receives the result of the image processing using the DNN after contraction from the DNN computation unit 300, and sends a signal to the contraction number setting unit 121 to adjust the contraction number based on the confirmed result of the recognition accuracy. At this time, as a result of confirming the recognition accuracy, in a case where the recognition has been sufficiently performed and further contraction can be performed, a signal is sent to the contraction number setting unit 121 so as to further increase the contraction number. On the other hand, as a result of confirming the recognition accuracy, in a case where the recognition is insufficient, a signal is sent to the contraction number setting unit 121 so as to reduce the contraction number.

FIG. 7 illustrates a detailed input/output of the recognition accuracy confirmation unit 123.

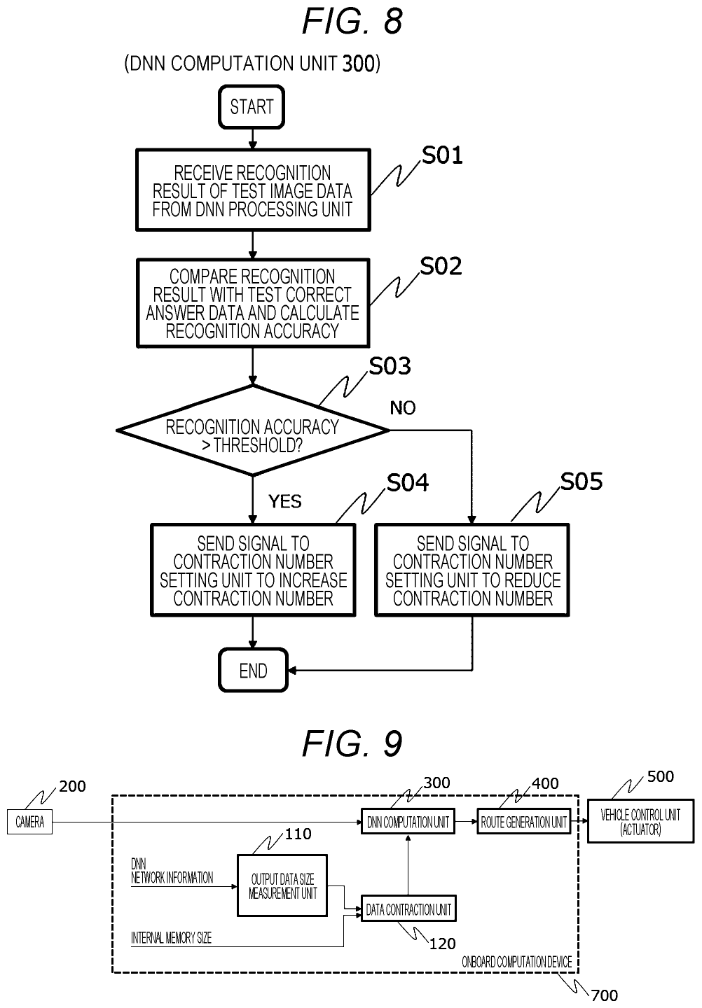

Hereinafter, the operation of the recognition accuracy confirmation unit 123 will be described using a specific example. FIG. 8 is a flowchart illustrating processing of the recognition accuracy confirmation unit 123.

The DNN contraction device 100 holds test image data in which a correct answer of what is in an image is known in advance and test correct answer data indicating the correct answer. The DNN computation unit 300 performs image processing on the test image data using the DNN after contraction, and the recognition accuracy confirmation unit 123 receives this recognition result (S01).

The recognition accuracy confirmation unit 123 compares the recognition result with the test correct answer data, calculates how much the DNN has been recognized, and calculates the recognition accuracy of the DNN after contraction (S02).

Then, the recognition accuracy is compared with a recognition accuracy threshold set in advance in the recognition accuracy confirmation unit 123 (S03), and in a case where the recognition accuracy is higher than the threshold, a signal is sent to the contraction number setting unit 121 to increase the contraction number (S04).

Further, in a case where the recognition accuracy is lower than the threshold, a signal is sent to the contraction number setting unit 121 to reduce the contraction number (S05).

As an example, it is assumed that there are 500 pieces of test image data and 500 pieces of correct data corresponding to the respective images. It is assumed that the recognition accuracy of the result of performing the image processing on 500 images is 55%. In addition, assuming that the threshold of the recognition accuracy set in advance is 50%, when a DNN after contraction is used, recognition with accuracy higher than the threshold can be performed. Therefore, the recognition accuracy confirmation unit 123 sends a signal to the contraction number setting unit 121 so as to increase the contraction number. As a result, it is possible to prevent a decrease in recognition accuracy due to excessive contraction of the DNN.

Features of the present embodiment can also be summarized as follows.

As illustrated in FIG. 7, the recognition accuracy confirmation unit 123 causes the contraction number setting unit 121 to reduce the contraction number in a case where the recognition accuracy when using the contracted DNN is less than the threshold, and causes the contraction number setting unit 121 to increase the contraction number in a case where the recognition accuracy is larger than the threshold. This makes it possible to suppress a decrease in recognition accuracy due to contraction of the DNN.

Specifically, the recognition accuracy confirmation unit 123 confirms the recognition accuracy of the contracted DNN using test image data and test correct answer data prepared in advance. As a result, the recognition accuracy of the contracted DNN can be standardized.

### Fourth Embodiment

Next, a fourth embodiment of the present invention will be described. FIG. 9 is a block diagram illustrating an example of a configuration diagram of an automatic driving system using an onboard computation device 700 of the present embodiment. In FIG. 9, the same names and numbers are assigned to blocks that perform the same processing as in FIG. 1, and unless otherwise described, the blocks are assumed to have the same or similar functions, and the description thereof will be omitted. The onboard computation device 700 in FIG. 9 is obtained by mounting the DNN contraction device 100 in FIG. 1 on a vehicle.

Note that the onboard computation device 700 of FIG. 9 includes the DNN computation unit 300 and the route generation unit 400 in addition to the DNN contraction device 100 of FIG. 1, but the configuration of FIG. 9 is the same as the configuration of FIG. 1 as an automatic driving system.

As illustrated in FIG. 9, the automatic driving system using the onboard computation device 700 according to the present embodiment includes an onboard computation device 700, a camera 200, and a vehicle control unit 500. Here, the onboard computation device 700 includes the output data size measurement unit 110, the data contraction unit 120, the DNN computation unit 300, and the route generation unit 400.

First, the operation of the DNN computation unit 300 will be described. The DNN computation unit 300 performs image recognition processing on the external information acquired from the camera 200 using the DNN after contraction which is output from the data contraction unit 120 described later. The route generation unit 400 generates an action plan such as the traveling direction and the traveling speed of the vehicle using the information of the recognition result processed by the DNN computation unit 300, and outputs the action plan to the vehicle control unit 500. The vehicle control unit 500 controls the vehicle based on the output from the route generation unit 400.

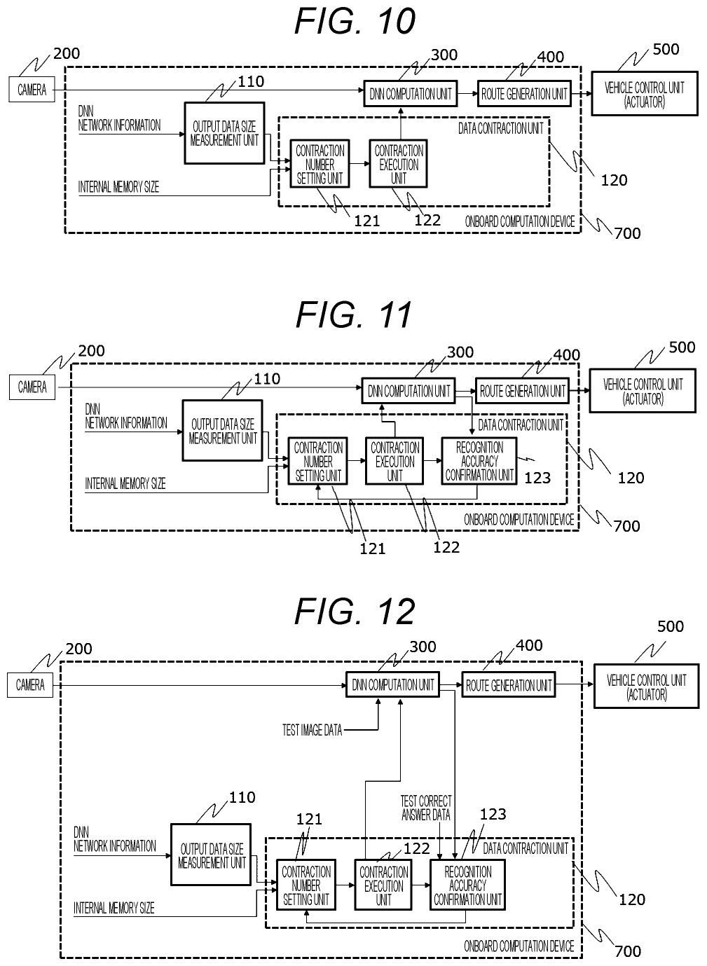

In addition, FIG. 10 illustrates a detailed view of the data contraction unit 120 of FIG. 9. In FIG. 10, the same names and numbers are assigned to blocks that perform the same processing as in FIG. 9, and the description thereof is omitted assuming that the blocks have the same or similar functions unless otherwise specified.

In FIG. 9, the data contraction unit 120 includes the contraction number setting unit 121 and the contraction execution unit 122. In the present embodiment, the contraction number setting unit 121 sets the contraction amount of the DNN so that the DNN computation data size is equal to or less than the memory size of the internal memory from the DNN computation data size and the internal memory size in the layer that is the output from the output data size measurement unit 110. The contraction execution unit 122 performs contraction of the DNN based on the contraction number set by the contraction number setting unit 121, and outputs the DNN after contraction to the DNN computation unit 300.

As a result, it is possible to perform contraction of the DNN assuming division by the internal memory size that cannot be considered in general Pruning, and it is possible to perform an efficient computation using the internal memory and to reduce the number of times of computation of the DNN and the number of times of data transfer to the external memory.

Hereinafter, the operation of the contraction number setting unit 121 will be described using a specific example.

As an example, it is assumed that the output data size measurement unit 110 measures that the DNN computation data size in a certain layer is 12 MB. In addition, it is assumed that the internal memory size of the device mounted with the DNN is 10 MB. The number of divisions of the computation data of the DNN at this time is ROUNDUP(12/10, 0)=2 from (Expression 3). However, at this time, only 2 MB of the internal memory size of 10 MB is used in the second division. That is, at this time, if the number of times of computation equal to or larger than the amount corresponding to 2 MB can be reduced, the number of divisions can be set to one, and the number of times of computation and the number of times of data transfer can be reduced.

Therefore, the contraction number setting unit 121 sets the number of times of contraction at which the DNN computation data after contraction in a certain layer is 10 MB or less, and outputs the contraction number to the contraction execution unit 122.

Features of the present embodiment can also be summarized as follows.

The onboard computation device 700 includes at least the DNN computation unit 300 that performs a DNN computation using an internal memory, in addition to the DNN contraction device 100 of the first embodiment. Specifically, the onboard computation device 700 further includes the route generation unit 400 that generates a route of the vehicle using the information of the object recognized by the DNN computation unit 300. As a result, the automatic driving of the vehicle can be performed using the DNN computation efficiently using the internal memory.

### Fifth Embodiment

Next, a fifth embodiment of the present invention will be described. FIG. 10 is a block diagram illustrating an example of a configuration diagram of an automatic driving system using the onboard computation device 700 of the present embodiment. In FIG. 10, the same names and numbers are assigned to blocks that perform the same processing as in FIG. 9, and the description thereof is omitted assuming that the blocks have the same or similar functions unless otherwise specified.

Note that the onboard computation device 700 of FIG. 10 includes the DNN computation unit 300 and the route generation unit 400 in addition to the DNN contraction device 100 of FIG. 5, but the configuration of FIG. 10 is the same as the configuration of FIG. 5 as an automatic driving system.

In the fourth embodiment, the contraction number setting unit 121 sets the contraction number so that the DNN computation data becomes equal to or less than the internal memory size, but when the DNN computation data is extremely large with respect to the internal memory size, it becomes difficult to contract the DNN computation data to the internal memory size or less. Therefore, if the computation data can be reduced to an integral multiple of the internal memory size in order to perform the contraction in consideration of the division by the internal memory size, the internal memory can be efficiently used and the computation can be performed without waste regardless of the scale of the DNN computation data and the internal memory size. Therefore, in the present embodiment, the contraction number setting unit 121 sets the contraction number such that the DNN computation data size becomes an integral multiple of the internal memory size from the DNN computation data size and the internal memory size in the layer that is the output from the output data size measurement unit 110.

Hereinafter, the operation of the contraction number setting unit 121 will be described using a specific example.

As an example, it is assumed that the output data size measurement unit 110 measures that the size of the DNN computation data in a certain layer is 102 MB. In addition, it is assumed that the internal memory size of the device mounting the DNN is 10 MB. The number of divisions of the computation data of the DNN at this time is ROUNDUP(102/10, 0)=11 from (Expression 3). However, at this time, only 2 MB of the internal memory size 10 MB is used in the eleventh division. That is, at this time, if the number of times of computation equal to or larger than the amount corresponding to 2 MB can be reduced, the number of divisions can be set to 10, and the number of times of computation and the number of times of data transfer can be reduced.

That is, at this time, the contraction number setting unit 121 sets the contraction number such that the DNN computation data size after contraction in a certain layer is 10 MB*10 times=100 MB or less, which is an integral multiple of the internal memory size.

Note that, in this example, the contraction number is set so as to reduce the number of divisions by the last one time, but the contraction amount may be set so as to reduce the number of divisions two or more times.

Features of the present embodiment can also be summarized as follows.

The onboard computation device 700 includes at least the DNN computation unit 300 that performs a DNN computation using an internal memory, in addition to the DNN contraction device 100 of the second embodiment. Specifically, the onboard computation device 700 further includes the route generation unit 400 that generates a route of the vehicle using the information of the object recognized by the DNN computation unit 300. As a result, the automatic driving of the vehicle can be performed using the DNN computation efficiently using the internal memory.

### Sixth Embodiment

Next, a sixth embodiment of the present invention will be described. FIG. 11 is a block diagram illustrating an example of a configuration diagram of an automatic driving system using the onboard computation device 700 of the present embodiment. In FIG. 11, the same names and numbers are assigned to blocks that perform the same processing as in FIG. 10, and the description thereof is omitted assuming that the blocks have the same or similar functions unless otherwise specified.

Note that the onboard computation device 700 of FIG. 11 includes the DNN computation unit 300 and the route generation unit 400 in addition to the DNN contraction device 100 of FIG. 6, but the configuration of FIG. 11 is the same as the configuration of FIG. 6 as an automatic driving system.

When the DNN contraction is performed, since a part of the computation is deleted, the recognition accuracy is reduced to some extent, but the recognition accuracy is not confirmed in the fourth and fifth embodiments. If the recognition accuracy is not confirmed, even computation that should not be deleted when recognizing an object is deleted, and the recognition accuracy necessary for automatic driving cannot be secured, and safety may be concerned.

In FIG. 11, a recognition accuracy confirmation unit 123 newly added from FIG. 10 receives the result of the image processing using the DNN after contraction from the DNN computation unit 300, and sends a signal to the contraction number setting unit 121 to adjust the contraction number based on the confirmed result of the recognition accuracy. At this time, as a result of confirming the recognition accuracy, in a case where the recognition has been sufficiently performed and further contraction can be performed, a signal is sent to the contraction number setting unit 121 so as to further increase the contraction number. On the other hand, as a result of confirming the recognition accuracy, in a case where the recognition is insufficient, a signal is sent to the contraction number setting unit 121 so as to reduce the contraction number.

FIG. 12 illustrates a detailed input/output of the recognition accuracy confirmation unit 123.

Hereinafter, the operation of the recognition accuracy confirmation unit 123 will be described using a specific example. FIG. 8 is a flowchart illustrating processing of the recognition accuracy confirmation unit 123.

The onboard computation device 700 holds test image data in which a correct answer of what is in an image is known in advance and test correct answer data indicating the correct answer. The DNN computation unit 300 performs image processing on the test image data using the DNN after contraction, and the recognition accuracy confirmation unit 123 receives this recognition result (S01).

The recognition accuracy confirmation unit 123 compares the recognition result with the test correct answer data, calculates how much the DNN has been recognized, and calculates the recognition accuracy of the DNN after contraction (S02).

Then, the recognition accuracy is compared with a recognition accuracy threshold set in advance in the recognition accuracy confirmation unit 123 (S03), and in a case where the recognition accuracy is higher than the threshold, a signal is sent to the contraction number setting unit 121 to increase the contraction number (S04).

Further, in a case where the recognition accuracy is lower than the threshold, a signal is sent to the contraction number setting unit 121 to reduce the contraction number (S05).

As an example, it is assumed that there are 500 pieces of test image data and 500 pieces of correct data corresponding to the respective images. It is assumed that the recognition accuracy of the result of performing the image processing on 500 images is 55%. In addition, assuming that the threshold of the recognition accuracy set in advance is 50%, when a DNN after contraction is used, recognition with accuracy higher than the threshold can be performed. Therefore, the recognition accuracy confirmation unit 123 sends a signal to the contraction number setting unit 121 so as to increase the contraction number. As a result, it is possible to prevent a decrease in recognition accuracy due to excessive contraction of the DNN.

Features of the present embodiment can also be summarized as follows.

The onboard computation device 700 includes at least the DNN computation unit 300 that performs a DNN computation using an internal memory, in addition to the DNN contraction device 100 of the third embodiment. Specifically, the onboard computation device 700 further includes the route generation unit 400 that generates a route of the vehicle using the information of the object recognized by the DNN computation unit 300. As a result, the automatic driving of the vehicle can be performed using the DNN computation efficiently using the internal memory.

### Seventh Embodiment

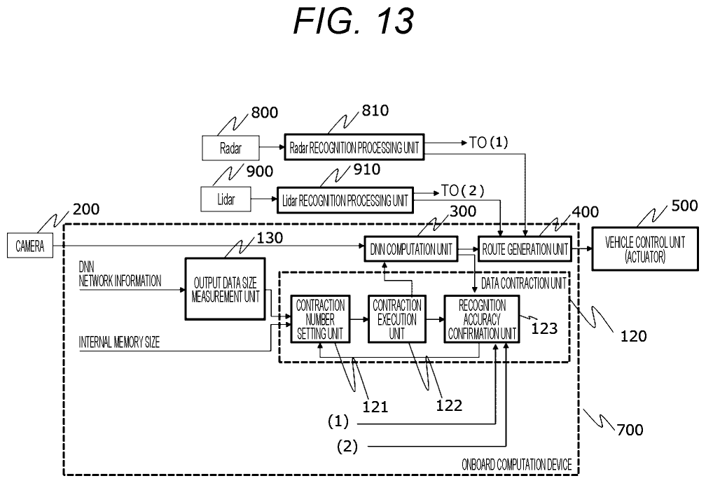

Next, a seventh embodiment of the present invention will be described. FIG. 13 is a block diagram illustrating an example of a configuration diagram of an automatic driving system using the onboard computation device 700 of the present embodiment. In FIG. 13, the same names and numbers are assigned to blocks that perform the same processing as in FIG. 11, and the description thereof is omitted assuming that the blocks have the same or similar functions unless otherwise specified.

In the sixth embodiment, the recognition accuracy using the test image is confirmed. However, in a case where the DNN computation unit 300 and the data contraction unit 120 are mounted on the vehicle, it is possible to confirm the recognition accuracy of the result by comparing the external information from the camera 200 with the results of other sensors in real time.

In FIG. 13, a Radar recognition processing unit 810 newly added from FIG. 10 processes the external information acquired by a Radar 800 and outputs a result of object recognition to the route generation unit 400 and the recognition accuracy confirmation unit 123. In addition, a Lidar recognition processing unit 910 processes external information acquired by a Lidar 900 and outputs a result of object recognition to the route generation unit 400 and the recognition accuracy confirmation unit 123.

The route generation unit 400 generates an action plan such as a traveling direction and a traveling speed of the vehicle based on the recognition results of the DNN computation unit 300, the Radar recognition processing unit 810, and the Lidar recognition processing unit 910. Further, the recognition accuracy confirmation unit 123 receives a result of object recognition by the DNN computation unit 300 processing the external information acquired by the camera 200, an output of the Radar recognition processing unit 810, and an output of the Lidar recognition processing unit 910.

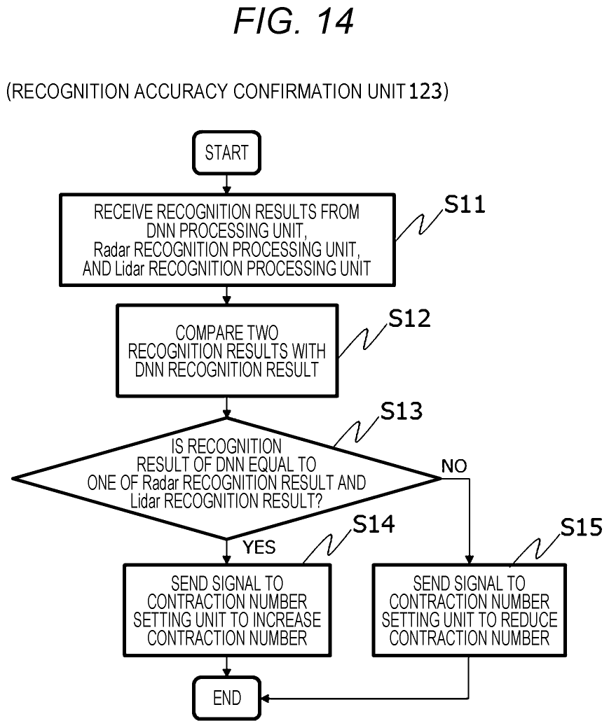

Hereinafter, the operation of the recognition accuracy confirmation unit 123 will be described using a specific example. FIG. 14 is a flowchart illustrating processing of the recognition accuracy confirmation unit 123.

The DNN computation unit 300 performs image processing on the external information from the camera 200 using the DNN after contraction, and the recognition accuracy confirmation unit 123 receives this recognition result. Further, the Radar recognition processing unit 810 processes the external information obtained from the Radar 800, and the recognition accuracy confirmation unit 123 receives this recognition result. Further, the Lidar recognition processing unit 910 processes the external information obtained from the Lidar 900, and the recognition accuracy confirmation unit 123 receives this recognition result (S11).

Next, these three recognition results are compared (S12). At that time, it is determined whether the output result of the DNN computation unit 300 matches at least one of the output from the Radar recognition processing unit 810 and the output of the Lidar recognition processing unit 910 (S13). In a case where the output result matches at least one of the results, it is determined that further contraction is possible, and a signal is sent to the contraction number setting unit 121 to increase the contraction number (S14).

Further, in a case where the result is different from any of the recognition results, it is determined that excessive contraction has been performed, and a signal is sent to the contraction number setting unit 121 to reduce the contraction number (S15).

As an example, it is assumed that, in the recognition result of the Lidar recognition processing unit 910, it is recognized that there are currently three vehicles and two pedestrians ahead. In the recognition result of the Radar recognition processing unit 810, it is assumed that it is recognized that there are two vehicles and two pedestrians ahead. At this time, it is assumed that it is recognized that there are two vehicles and one pedestrian in the output from the DNN computation unit 300. At this time, both the recognition result of the Lidar recognition processing unit 910 and the recognition result of the Radar recognition processing unit 810 have different results. Therefore, at this time, the recognition accuracy confirmation unit 123 sends a signal to the contraction number setting unit 121 so as to reduce the contraction number. As a result, it is possible to prevent a decrease in recognition accuracy due to excessive contraction of the DNN.

Note that, in the present embodiment, the recognition results of the Lidar and the Radar are compared with the recognition result of the DNN for confirmation of recognition accuracy, but this is not limited to the Lidar and the Radar as long as it is a sensor capable of acquiring the distance to an external object or the type of the object as an input of the DNN. Further, in the present embodiment, the number of sensors for confirming recognition accuracy is two, but may be any number as long as the number is two or more.

The present embodiment can also be summarized as follows.

As illustrated in FIG. 13, the DNN computation unit 300 recognizes an object from the external information sensed by the camera 200 as a main sensor. The recognition accuracy confirmation unit 123 compares the information of the object recognized from the external information sensed by the Radar 800 or the Lidar 900 as a sub sensor different from the camera 200 with the information of the object recognized by the DNN computation unit 300, and confirms the recognition accuracy of the contracted DNN. This eliminates the need for the test image data and the test correct answer data.

Specifically, there are a plurality of sub sensors (Radar 800, Lidar 900). In a case where the information of the object recognized by the DNN computation unit 300 is different from the information of the object recognized from the external information sensed by at least one sub sensor (Radar 800, Lidar 900), the recognition accuracy confirmation unit 123 causes the contraction number setting unit 121 to reduce the contraction number. This makes it possible to suppress a decrease in recognition accuracy due to contraction of the DNN.

In addition to the above configuration, the onboard computation device 700 includes at least a DNN computation unit 300 that performs a DNN computation using an internal memory. Specifically, the onboard computation device 700 further includes the route generation unit 400 that generates a route of the vehicle using the information of the object recognized by the DNN computation unit 300. As a result, the automatic driving of the vehicle can be performed using the DNN computation efficiently using the internal memory.

The present invention is not limited to the embodiments described above, but includes various modifications. For example, the above embodiments have been described in detail for easy understanding of the invention, and the invention is not necessarily limited to having all the configurations described. Some of the configurations of a certain embodiment may be replaced with the configurations of the other embodiments, and the configurations of the other embodiments may be added to the configurations of the subject embodiment. It is possible to add, delete, and replace other configurations for a part of the configuration of each embodiment.

In addition, a part or all of the respective configurations and functions may be realized in hardware by, for example, a designed integrated circuit. The configurations and the functions may be realized in software such that a processor analyzes and performs a program which realizes each function. The information such as the programs, tables, files, and the like for realizing the respective functions can be placed in a recording device such as a memory, a hard disk, or a Solid State Drive (SSD), or a recording medium such as an IC card, an SD card, a DVD, or the like.

Further, the embodiment of the invention may be configured as follows.
(1). A DNN contraction device including: a DNN computation unit configured to perform a DNN computation for at least one or more layers as a unit; an output data size measurement unit configured to measure a size of output data in a certain layer from DNN network information; and a data contraction unit configured to set a contraction number of the certain layer based on a measurement result of the output data size measurement unit and a memory size of an internal memory.
(2). In the DNN contraction device according to (1), the data contraction unit includes a contraction number setting unit that sets a contraction number of the certain layer so that an output data size becomes equal to or smaller than an internal memory size, and a contraction execution unit that reduces DNN according to the set contraction number.
(3). In the DNN contraction device according to (1), the data contraction unit includes a contraction number setting unit that sets a contraction number of the certain layer so that an output data size becomes an integral multiple of an internal memory size, and a contraction execution unit that reduces DNN according to the set contraction number.
(4). In the DNN contraction device according to (2) or (3), including a recognition accuracy confirmation unit that compares recognition accuracy when using a DNN network contracted by the contraction execution unit with a preset threshold, in which the recognition accuracy confirmation unit adjusts the contraction number of the contraction number setting unit to reduce the contraction number when the recognition accuracy is less than the threshold, and to increase the contraction number when the recognition accuracy is greater than the threshold, or further execute reduction in a certain layer.
(5). In the DNN contraction device according to (4), recognition accuracy of a DNN reduced by the contraction execution unit is calculated using test image data and test correct answer data prepared in advance by the recognition accuracy confirmation unit.
(6). An onboard computation device including: a DNN computation unit configured to perform a DNN computation for at least one or more layers as a unit; an output data size measurement unit configured to measure a size of output data in a certain layer from DNN network information; and a data contraction unit configured to set a contraction number of the certain layer based on a measurement result of the output data size measurement unit and a memory size of an internal memory.
(7). In the onboard computation device according to (6), the data contraction unit includes a contraction number setting unit that sets a contraction number of the certain layer so that an output data size becomes equal to or smaller than an internal memory size, and a contraction execution unit that reduces DNN according to the set contraction number.
(8). In the onboard computation device according to (6), the data contraction unit includes a contraction number setting unit that sets a contraction number of the certain layer so that an output data size becomes an integral multiple of an internal memory size, and a contraction execution unit that reduces DNN according to the set contraction number.
(9). In the onboard computation device according to (7) or (8), including a recognition accuracy confirmation unit that compares recognition accuracy when using a DNN network contracted by the contraction execution unit with a preset threshold, in which the recognition accuracy confirmation unit adjusts the contraction number of the contraction number setting unit to reduce the contraction number when the recognition accuracy is less than the threshold, and to increase the contraction number when the recognition accuracy is greater than the threshold, or further execute reduction in a certain layer.
(10). In the onboard computation device according to (9), recognition accuracy of a DNN reduced by the contraction execution unit is calculated using test image data and test correct answer data prepared in advance by the recognition accuracy confirmation unit.
(11). In the onboard computation device computing device according to (9), recognition results of a plurality of sensors recognizing an outside world by the recognition accuracy confirmation unit are compared, and recognition accuracy of a DNN contracted by the contraction execution unit is calculated.

According to (1) to (11), it is possible to efficiently utilize the internal memory by performing the DNN contraction processing based on the memory size of the internal memory of the DNN computation unit (computation device) on which the DNN is mounted. This makes it possible to reduce the number of times of computation in the DNN computation and the number of times of data transfer between the DNN mounting device and the external memory.

### Reference Signs List

100 DNN contraction device
110 output data size measurement unit
120 data contraction unit
121 contraction number setting unit
122 contraction execution unit
123 recognition accuracy confirmation unit
200 camera
300 DNN computation unit
400 route generation unit
500 vehicle control unit
610 input layer
620 intermediate layer
630 output layer
700 onboard computation device
800 Radar
810 Radar recognition processing unit
900 Lidar
910 Lidar recognition processing unit

1. A DNN contraction device that outputs a contracted DNN to a DNN computation unit that performs a DNN computation using an internal memory, the DNN contraction device comprising:
an output data size measurement unit that measures an output data size in a DNN layer from DNN network information; and
a data contraction unit that sets a contraction number of the DNN layer based on the output data size and a memory size of the internal memory.

2. The DNN contraction device according to claim 1, wherein
the data contraction unit includes:
a contraction number setting unit that sets the contraction number of the DNN layer such that the output data size is equal to or less than the memory size of the internal memory; and
a contraction execution unit that contracts the DNN according to the set contraction number.

3. The DNN contraction device according to claim 1, wherein
the data contraction unit includes:
a contraction number setting unit that sets the contraction number of the DNN layer such that the output data size is an integral multiple of the memory size of the internal memory; and
a contraction execution unit that contracts the DNN according to the set contraction number.

4. The DNN contraction device according to claim 3, comprising
a recognition accuracy confirmation unit that causes the contraction number setting unit to reduce the contraction number in a case where recognition accuracy at a time of using the contracted DNN is less than a threshold, and causes the contraction number setting unit to increase the contraction number in a case where the recognition accuracy is larger than a threshold.

5. The DNN contraction device according to claim 4, wherein
the recognition accuracy confirmation unit is configured to
confirm recognition accuracy of the contracted DNN by using test image data and test correct answer data prepared in advance.

6. The DNN contraction device according to claim 4, wherein
the DNN computation unit is configured to
recognize an object from external information sensed by a main sensor, and
the recognition accuracy confirmation unit is configured to
compare information of an object recognized from external information sensed by a sub sensor different from the main sensor with information of the object recognized by the DNN computation unit, and confirm recognition accuracy of the contracted DNN.

7. The DNN contraction device according to claim 6, wherein
the sub sensor includes a plurality of sub sensors, and
the recognition accuracy confirmation unit is configured to,
in a case where the information of the object recognized by the DNN computation unit is different from the information of the object recognized from the external information sensed by at least one of the sub sensors, the contraction number setting unit reduces the contraction number.

8. An onboard computation device comprising the DNN contraction device according to claim 1, the onboard computation device comprising
the DNN computation unit that performs a DNN computation using an internal memory.

9. The onboard computation device according to claim 8, comprising
a route generation unit that generates a route of a vehicle using information of an object recognized by the DNN computation unit.
